(19) United States
(12) Patent Application Publication
(10) Pub. No.: US 2010/0232617 A1
(43) Pub. Date: Sep. 16, 2010

(54) MULTI-ELEMENT ELECTROACOUSTICAL TRANSDUCING

(76) Inventors: Klaus Hartung, Hopkinton, MA (US); Roman Katzer, Esslingen (DE)

Correspondence Address: Bose Corporation;c/o Donna Griffiths, The Mountain, MS 40, IP Legal - Patent Support, Framingham, MA, 01701, US

(21) Appl. No.: 12/771,541

(22) Filed: Apr. 30, 2010

Related U.S. Application Data
(63) Continuation-in-part of application No. 11/426,512, filed on Jun. 26, 2006.
Application No. 11/426,512 is a continuation-in-part of application No. 11/499,014, filed on Aug. 4, 2006.
(60) Provisional application No. 61/174,726, filed on May 1, 2009.

(51) Int. Cl. G10K 11/16

(52) U.S. Cl. 381/71.7

(57) ABSTRACT

An acoustic apparatus including circuitry to correct for acoustic cross-coupling of acoustic drivers mounted in a common acoustic enclosure. A plurality of acoustic drivers are mounted in the acoustic enclosure so that motion of each of the acoustic drivers causes motion in each of the other acoustic drivers. A canceller cancels the motion of each of the acoustic drivers caused by motion of each of the other acoustic drivers. A cancellation adjuster cancels the motion of each of the acoustic drivers that may result from the operation of the canceller.

### CLAIM OF PRIORITY

This application is a continuation-in-part of, and claims priority to, U.S. patent application Ser. No. 11/499,014 filed Aug. 4, 2006 and published Feb. 7, 2008 as published Pat. App. US-2008-0031472-A1 and also claims priority to U.S. Provisional Patent App. 61/174,726, filed May 1, 2009.

### BACKGROUND

This specification describes a loudspeaker system in which two or more acoustic drivers share a common enclosure.

### SUMMARY

In one aspect, an apparatus includes an acoustic enclosure, a plurality of acoustic drivers mounted in the acoustic enclosure so that motion of each of the acoustic drivers causes motion in each of the other acoustic drivers, a canceller, to cancel the motion of each of the acoustic drivers caused by motion of each of the other acoustic drivers, and a cancellation adjuster, to cancel the motion of each of the acoustic drivers that may result from the operation of the canceller. The cancellation adjuster may adjust for undesirable phase and frequency response effects that result from the operation of the canceller. The

cancellation adjuster may apply the transfer function matrix

$$[ \begin{matrix}{H}_{11} … {H}_{1 n} \\ ⋮ \\ {H}_{1 n} … {H}_{nn}\end{matrix} ]$$

where each of the matrix elements H_{xy} represents a transfer function from an audio signal Vₓ applied to the input of acoustic driver x to motion represented by velocity S_{y} of acoustic driver y. The acoustic drivers may be a components of a directional array. The acoustic drivers may be components of a two-way speaker.

In another aspect, a method of operating a loudspeaker having at least two acoustic drivers in a common enclosure, includes determining the effect of the motion of a first acoustic driver on the motion of a second acoustic driver; developing a first correction audio signal to correct for the effect of the motion of the first acoustic driver on the motion of the second acoustic driver; determining the effect on the motion of the first acoustic driver of the transducing of the correction audio signal by the second acoustic driver; and developing a second correction audio signal to correct for the effect on the motion of the first acoustic driver of the transducing of the first correction audio signal by the second acoustic driver. The correction audio signal may correct the frequency response and the phase effects on the motion of the first acoustic driver of the transducing of the correction audio signal by the second acoustic driver. The second correction audio signal may be

$$\frac{1}{det H} ,$$

where H is the transfer function matrix

$$[ \begin{matrix}{H}_{11} … {H}_{1 n} \\ ⋮ \\ {H}_{1 n} … {H}_{nn}\end{matrix} ]$$

where the matrix elements H_{xy} represent the transfer function from an audio signal Vₓ applied to the input of acoustic driver x to motion represented by velocity S_{y} of acoustic driver y. The method may further include determining matrix elements H_{xy} by causing acoustic driver y to transduce an audio signal, and measuring the effect on acoustic driver x of the transducing by acoustic driver y by a laser vibrometer. The method of claim 8, wherein the motion of acoustic driver is represented by a displacement.

### BRIEF DESCRIPTION OF THE DRAWING

FIGS. 1A-1D are block diagrams of an audio system;

FIG. 2 is a block diagram of an audio system having cross-coupling canceller and a cancellation adjuster;

FIG. 3 is a block diagram of an audio system showing elements of the canceller;

FIG. 4 is a block diagram of an audio system showing elements of the canceller and the cancellation adjuster;

FIG. 5 is a block diagram of an audio system having three transducer;

FIG. 6 is a block diagram of an alternate configuration of an audio system having a cross-coupling canceller;

FIG. 7 is s plot of cone velocity vs. frequency; and

FIG. 8 is a plot of phase vs. frequency.

### DETAILED DESCRIPTION

Though the elements of several views of the drawing are shown and described as discrete elements in a block diagram and may be referred to as “circuitry”, unless otherwise indicated, the elements may be implemented as one of, or a combination of, analog circuitry, digital circuitry, or one or more microprocessors executing software instructions. The software instructions may include digital signal processing (DSP) instructions. Unless otherwise indicated, signal lines may be implemented as discrete analog or digital signal lines, as a single discrete digital signal line with appropriate signal processing to process separate streams of audio signals, or as elements of a wireless communication system. Unless otherwise indicated, audio signals may be encoded in either digital or analog form. For convenience, “radiating sound waves corresponding to channel x” will be expressed as “radiating channel x.”

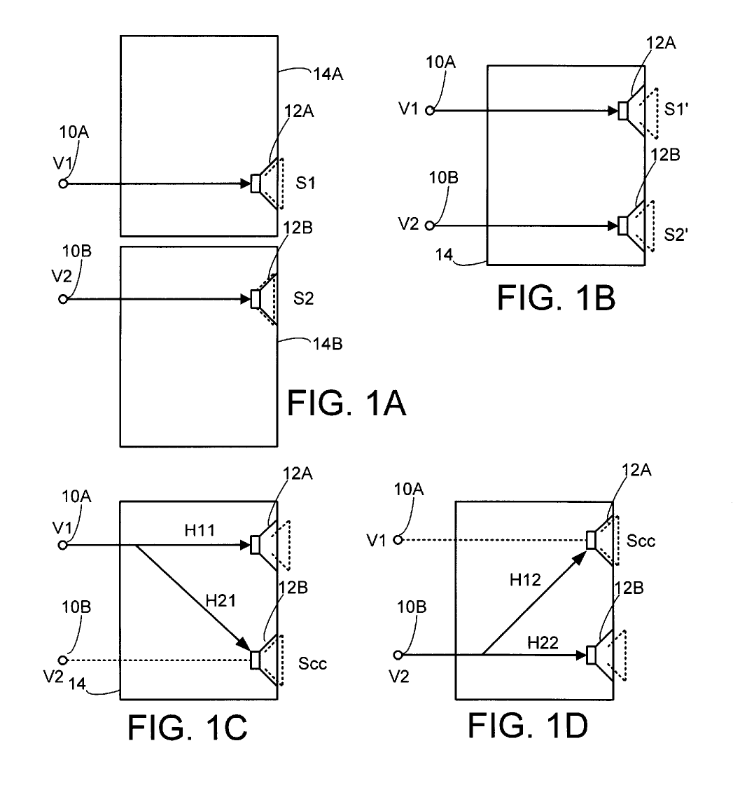

Referring to FIG. 1A, there is shown a block diagram of an acoustic system. Audio signal source 10A is coupled to acoustic driver 12A that is mounted in enclosure 14A. Audio signal source 10B is coupled to acoustic driver 12B that is mounted in enclosure 14B. Acoustic enclosure 14A is acoustically and mechanically isolated from acoustic enclosure 14B. Driving acoustic driver 12A by an audio signal represented by voltage V₁ results in desired motion S₁ which results in the radiation of acoustic energy. The motion can be expressed as a velocity or a displacement; for convenience, the following explanation will express motion as a velocity. Driving acoustic driver 12B by an audio signal represented by voltage V₂ results in desired motion S₂.

In the audio system of FIG. 1B, audio signal source 10A is coupled to acoustic driver 12A. Audio signal source 10B is coupled to acoustic driver 12B. Acoustic drivers 12A and 12B are mounted in enclosure 14, which has the same volume as enclosures 14A and 14B. Driving acoustic driver 12A by an audio signal represented by voltage V₁ results in motion S₁′ which may not be equal to desired motion S₁ because of acoustic cross-coupling, either through the air volume in the shared enclosure or mechanical coupling through the shared enclosure, or both. Similarly, driving acoustic driver 12B by an audio signal represented by voltage V₂ results in motion S₂′ which may not be equal to desired motion S₂.

The effect of cross-coupling can be seen in FIG. 1C, in which applying an acoustic signal represented by voltage V₁ to acoustic driver 12A and applying no signal (indicated by the dashed line between audio signal source 10B and acoustic driver 12B) to acoustic driver 12B results in cross-coupling induced motion S_{cc} of acoustic driver 12B. In FIG. 1D, applying an acoustic signal represented by voltage V₂ to acoustic driver 12B and applying no signal (indicated by the dashed line between audio signal source 10A and acoustic driver 12A) to acoustic driver 12A results in cross-coupling induced motion S_{cc} of acoustic driver 12A. For the purpose of the explanations following, transfer function H₁₁ is the transfer function from voltage V₁. to velocity S₁, transfer function H₁₂ is the transfer function from voltage V₂ to velocity S₁, transfer function H₂₁ is the transfer function from voltage V₁. to velocity S₂, and transfer function H₂₂ is the transfer function from voltage V₂ to velocity S₂. In the explanations that follow, an acoustic driver with an audio signal applied (such as acoustic driver 12A of FIG. 1C and acoustic driver 12B of FIG. 1D) will be referred to as a “primary acoustic driver”; an acoustic driver without a signal applied (for example acoustic driver 12B of FIG. 1C and acoustic driver 12A of FIG. 1D) that moves responsive to an audio signal being applied to a primary acoustic driver will be referred to as a “secondary acoustic driver”.

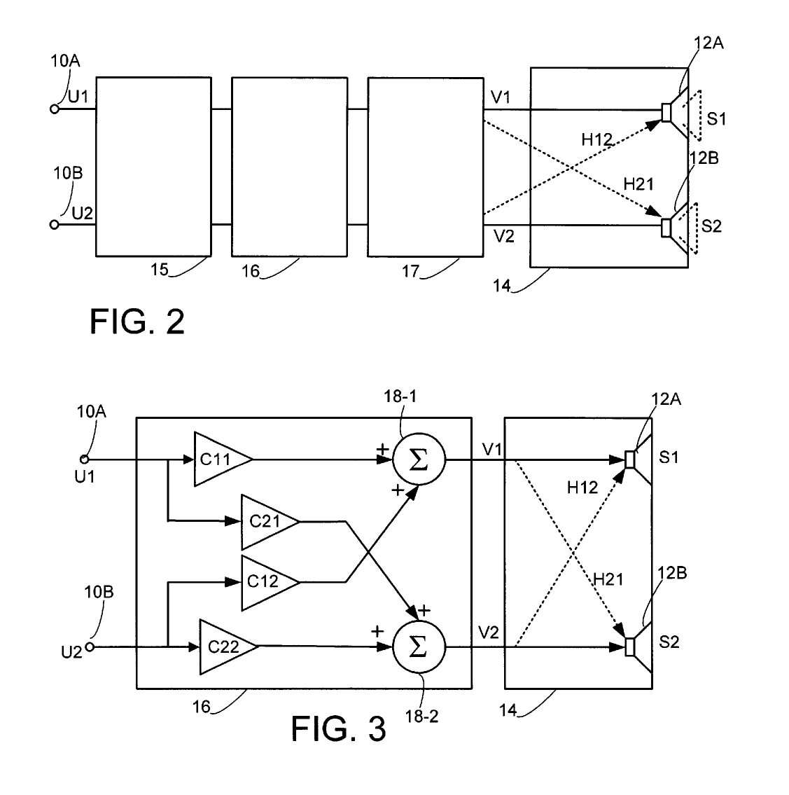

FIG. 2 includes the elements of FIG. 1B, and in addition includes a canceller 16, cancellation adjuster 15, and conventional signal processor 17. The canceller 16 modifies the input audio signals U₁ and U₁ to cancel transfer function H₁₂ and transfer function H₂₁ (as indicated by the dashed lines) to provide modified signals V₁ and V₂ which result in the desired motion S₁ and S₂ of acoustic drivers 12A and 12B, respectively. The cancellation adjuster 15 adjusts the signal to cancel undesirable effects that may result from the operation of the canceller, such as effects on the phase or on the frequency response. The conventional signal processor 17 includes processing that is not related to cross-coupling cancellation, for example equalization for room effects; equalization for undesired effects on frequency response of the acoustic drivers, amplifiers, or other system components; time delays; array processing such as phase reversal or polarity inversions; and the like. Canceller 16, cancellation adjuster 15, and conventional signal processor 17 can be in any order. For clarity, conventional signal processor 17 will not be shown in subsequent figures.

Actual implementations of acoustic system of FIG. 2 is most conveniently performed by a digital signal processor.

FIG. 3 shows the canceller 16 in more detail; cancellation adjuster 15 is not shown in this view and will be discussed below. Canceller 16 includes canceling transfer function C₁₁ coupling signal U₁ and summer 18A, canceling transfer function C₂₁ coupling signal U₁ and summer 18B, canceling transfer function C₂₂ coupling signal U₂ and summer 18B, canceling transfer function C₁₂ coupling signal U₂ and summer 18A. Summer 18A is coupled to acoustic driver 12A and summer 18B is coupled to acoustic driver 12B.

Canceling transfer functions C₁₁, C₂₁, C₂₂, and C₁₂ can be derived as follows. The relationships of FIGS. 1C and 1D can be expressed mathematically as

H₁₁·V₁+H₁₂·V₂=S₁

H₂₁·V₁+H₂₂·V₂=S₂

The notation can be simplified by transforming this set of linear equations into matrix form. The transfer function matrix H contains all transmission paths in the system:

$$H = [ \begin{matrix}{H}_{11} & {H}_{12} \\ {H}_{21} & {H}_{22}\end{matrix} ]$$

The input voltages are grouped into a vector v and the velocity or displacement into a vector S. In matrix notation, the system is described as

$$[ \begin{matrix}{H}_{11} & {H}_{12} \\ {H}_{21} & {H}_{22}\end{matrix} ] \cdot ( \begin{matrix}{V}_{1} \\ {V}_{2}\end{matrix} ) = ( \begin{matrix}{S}_{1} \\ {S}_{2}\end{matrix} )$$

Or simply

H·\vec{V}=\vec{S}

The relation between the input voltage and output voltage of the canceller is described by the linear equations:

C₁₁·U₁+C₁₂·U₂=V₁

C₂₁·U₁+C₂₂·U₂=V₂

Or in matrix notation

$$[ \begin{matrix}{C}_{11} & {C}_{12} \\ {C}_{21} & {C}_{22}\end{matrix} ] \cdot ( \begin{matrix}{U}_{1} \\ {U}_{2}\end{matrix} ) = ( \begin{matrix}{V}_{1} \\ {V}_{2}\end{matrix} )$$

$$C \cdot \vec{U} = \vec{V}$$

The velocities of the acoustic drivers can now be expressed as a function of the input voltages to the canceller.

$$H \cdot C \cdot \vec{U} = \vec{S} \\ ⇔ [ \begin{matrix}{H}_{11} & {H}_{12} \\ {H}_{21} & {H}_{22}\end{matrix} ] \cdot [ \begin{matrix}{C}_{11} & {C}_{12} \\ {C}_{21} & {C}_{22}\end{matrix} ] \cdot ( \begin{matrix}{U}_{1} \\ {U}_{2}\end{matrix} ) = ( \begin{matrix}{S}_{1} \\ {S}_{2}\end{matrix} )$$

The overall system transfer function is described by the product of H and C. We can simplify this equation by defining a matrix T, which describes the entire system transfer function.

H·C=T

With this, the equation of the input-output relationship of the system can be simplified to:

$$T \cdot \vec{U} = \vec{S} \\ ⇔ [ \begin{matrix}{T}_{11} & {T}_{12} \\ {T}_{21} & {T}_{22}\end{matrix} ] \cdot ( \begin{matrix}{U}_{1} \\ {U}_{2}\end{matrix} ) = ( \begin{matrix}{S}_{1} \\ {S}_{2}\end{matrix} )$$

T also includes operations of conventional signal processor 17 and cancellation adjuster 15.

Assuming that the desired system transfer function T and the matrix H are known, the equation above can be solved for the canceller matrix C:

C=H⁻¹·T
where H⁻¹ is the matrix inverse of H:

$$\begin{matrix}{H}^{- 1} = {[ \begin{matrix}{H}_{11} & {H}_{12} \\ {H}_{21} & {H}_{22}\end{matrix} ]}^{- 1} \\ = \frac{1}{{H}_{11} \cdot {H}_{22} - {H}_{12} \cdot {H}_{21}} \cdot [ \begin{matrix}{H}_{22} & {H}_{12} \\ - {H}_{21} & {H}_{11}\end{matrix} ] \\ = \frac{1}{det H} \cdot [ \begin{matrix}{H}_{22} & - {H}_{12} \\ - {H}_{21} & {H}_{11}\end{matrix} ]\end{matrix}$$

det H is the determinant of matrix H:

det H=H₁₁·H₂₂−H₁₂·H₂₁

Written out in matrix notation:

$$\begin{matrix}[ \begin{matrix}{C}_{11} & {C}_{12} \\ {C}_{21} & {C}_{22}\end{matrix} ] = \frac{1}{det H} \cdot [ \begin{matrix}{H}_{22} & - {H}_{12} \\ - {H}_{21} & {H}_{11}\end{matrix} ] \cdot [ \begin{matrix}{T}_{11} & {T}_{12} \\ {T}_{21} & {T}_{22}\end{matrix} ] \\ = \frac{1}{det H} \cdot [ \begin{matrix}\begin{matrix}{T}_{11} \cdot {H}_{22} - \\ {T}_{21} {H}_{12}\end{matrix} & \begin{matrix}{T}_{12} \cdot {H}_{22} - \\ {T}_{22} \cdot {H}_{12}\end{matrix} \\ \begin{matrix}- {T}_{11} \cdot {H}_{21} + \\ {T}_{21} \cdot {H}_{11}\end{matrix} & \begin{matrix}- {T}_{12} \cdot {H}_{21} + \\ {T}_{22} \cdot {H}_{11}\end{matrix}\end{matrix} ]\end{matrix}$$

Thus, the coefficients of C are

$${C}_{11} = \frac{{T}_{11} \cdot {H}_{22} - {T}_{21} \cdot {H}_{12}}{det H} {C}_{12} = \frac{{T}_{12} \cdot {H}_{22} - {T}_{22} \cdot {H}_{12}}{det H}$$

$${C}_{21} = \frac{- {T}_{11} \cdot {H}_{21} + {T}_{21} \cdot {H}_{11}}{det H} {C}_{22} = \frac{- {T}_{12} \cdot {H}_{21} + {T}_{22} \cdot {H}_{11}}{det H}$$

The denominators in these fractions are the same.

The concept described above with canceller matrix and target function can be universally applied to enclosures with more than two acoustic drivers. For a system with n acoustic drivers the transfer function from the electrical inputs to the velocities of the cones would be described by an nxn matrix. The elements on the main diagonal describe the actively induced cone motion. All other elements describe the acoustic cross-coupling between all cones. The equalization matrix will also be an nxn matrix.

It should be noted that this method can be applied to systems with different acoustic drivers, for example a loudspeaker system with a mid-range acoustic driver and a bass acoustic driver sharing the same acoustic volume. This will result in an asymmetric transfer function matrix but can be solved using the same methods.

The elements in the target function matrix can describe arbitrary responses, such as general equalizer functions. This also allows to control the relative amplitude and phase of all transducers (e.g. for acoustic arrays).

C can be calculated in either frequency or time domain. When the coefficients of the target matrix have been determined and the voltage to velocity or displacement transfer functions Hₓₓ have been measured, the coefficients of C are derived from those functions as described above.

Solving in the time domain always yields stable and causal filters. For this, the corresponding impulse responses for the matrix elements are determined. In this case, inverses of the impulse responses are determined by least-mean-squares (LMS) approximation. Information on LMS approximations can be found in Proakis and Manolakis, Digital Signal Processing: Principles, Algorithms and Applications Prentice Hall; 3rd edition (Oct. 5, 1995), ISBN-10: 0133737624, ISBN-13: 978-0133737622. The impulse responses can also be determined by other types of recursive filters.

The general solution for a 2×2 target matrix (a system with two acoustic drivers) is:

$$H \cdot C \cdot \vec{U} = \vec{S} \\ ⇔ [ \begin{matrix}{H}_{11} & {H}_{12} \\ {H}_{21} & {H}_{22}\end{matrix} ] \cdot [ \begin{matrix}{C}_{11} & {C}_{12} \\ {C}_{21} & {C}_{22}\end{matrix} ] \cdot ( \begin{matrix}{U}_{1} \\ {U}_{2}\end{matrix} ) = ( \begin{matrix}{S}_{1} \\ {S}_{2}\end{matrix} )$$

$$\begin{matrix}[ \begin{matrix}{C}_{11} & {C}_{12} \\ {C}_{21} & {C}_{22}\end{matrix} ] = \frac{1}{det H} \cdot [ \begin{matrix}{H}_{22} & - {H}_{12} \\ - {H}_{21} & {H}_{11}\end{matrix} ] \cdot [ \begin{matrix}{T}_{11} & {T}_{12} \\ {T}_{21} & {T}_{22}\end{matrix} ] \\ = \frac{1}{det H} \cdot [ \begin{matrix}\begin{matrix}{T}_{11} \cdot {H}_{22} - \\ {T}_{21} {H}_{12}\end{matrix} & \begin{matrix}{T}_{12} \cdot {H}_{22} - \\ {T}_{22} \cdot {H}_{12}\end{matrix} \\ \begin{matrix}- {T}_{11} \cdot {H}_{21} + \\ {T}_{21} \cdot {H}_{11}\end{matrix} & \begin{matrix}- {T}_{12} \cdot {H}_{21} + \\ {T}_{22} \cdot {H}_{11}\end{matrix}\end{matrix} ]\end{matrix}$$

This is the same solution as described above.

Ideally, each acoustic driver's motion would be dependent on its corresponding input signal only. This would be represented as:

$$[ \begin{matrix}{H}_{11} & {H}_{12} \\ {H}_{21} & {H}_{22}\end{matrix} ] \cdot [ \begin{matrix}{C}_{11} & {C}_{12} \\ {C}_{21} & {C}_{22}\end{matrix} ] = [ \begin{matrix}{T}_{11} & 0 \\ 0 & {T}_{22}\end{matrix} ]$$

Only the diagonal elements of the target matrix are non-zero here.
The solution of this system is

$$\begin{matrix}[ \begin{matrix}{C}_{11} & {C}_{12} \\ {C}_{21} & {C}_{22}\end{matrix} ] = \frac{1}{det H} \cdot [ \begin{matrix}{H}_{22} & - {H}_{12} \\ - {H}_{21} & {H}_{11}\end{matrix} ] \cdot [ \begin{matrix}{T}_{11} & 0 \\ 0 & {T}_{22}\end{matrix} ] \\ = \frac{1}{det H} \cdot [ \begin{matrix}{T}_{11} \cdot {H}_{22} & - {T}_{22} \cdot {H}_{12} \\ - {T}_{11} \cdot {H}_{21} & {T}_{22} \cdot {H}_{11}\end{matrix} ]\end{matrix}$$

Thus, the coefficients of C are

$${C}_{11} = \frac{{T}_{11} \cdot {H}_{22}}{det H} {C}_{12} = \frac{- {T}_{22} \cdot {H}_{12}}{det H}$$

$${C}_{21} = \frac{- {T}_{11} \cdot {H}_{21}}{det H} {C}_{22} = \frac{{T}_{22} \cdot {H}_{11}}{det H}$$

Which can be expressed as:

$${C}_{11} = \frac{1}{det H} \cdot {T}_{11} \cdot {H}_{22}$$

$${C}_{12} = \frac{1}{det H} \cdot {T}_{22} \cdot ( - {H}_{12} ) \\ {C}_{21} = \frac{1}{det H} \cdot {T}_{11} \cdot ( - {H}_{21} )$$

$${C}_{22} = \frac{1}{det H} \cdot {T}_{22} \cdot {H}_{11}$$

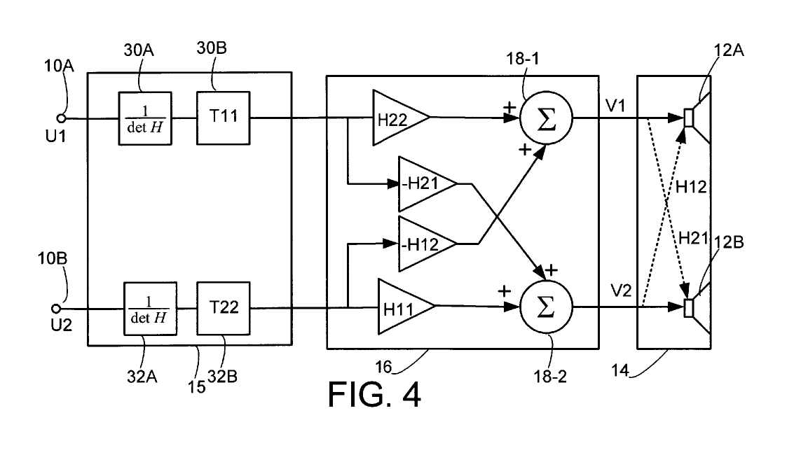

Common coefficients can be moved out of the canceller system, leaving coefficients that are different from unity only in the cross-paths. Referring to FIG. 4, the operations represented by transfer functions 30A and 32A, and 30B, and 32B comprise the operations performed by cancellation adjuster 15. In other implementations, elements 30B and 32B (the target transfer functions elements T₁₁−Tₙₙ), may be applied by the canceller 16. Performing transfer function elements T₁₁−Tₙₙ in either the cancellation adjuster 15 or the canceller 16 means that signal processing not related to cross-coupling, for example, for example equalization for room effects, equalization for undesired effects on frequency response of the acoustic drivers, amplifiers, or other system components, time delays, array processing such as phase reversal or polarity inversions, and the like can be done by the canceller 16 or the cancellation adjuster 15, which eliminates the need for the conventional signal processor 17 of FIG. 2.

If both acoustic drivers are driven by a single input (for example in a directional array), the elements of the second column in T are zero because the array is only driven by one input:

$$[ \begin{matrix}{H}_{11} & {H}_{12} \\ {H}_{21} & {H}_{22}\end{matrix} ] \cdot [ \begin{matrix}{C}_{11} & {C}_{12} \\ {C}_{21} & {C}_{22}\end{matrix} ] = [ \begin{matrix}{T}_{11} & 0 \\ {T}_{21} & 0\end{matrix} ]$$

The solution is

$$\begin{matrix}[ \begin{matrix}{C}_{11} & {C}_{12} \\ {C}_{21} & {C}_{22}\end{matrix} ] = \frac{1}{det H} \cdot [ \begin{matrix}{H}_{22} & - {H}_{12} \\ - {H}_{21} & {H}_{11}\end{matrix} ] \cdot [ \begin{matrix}{T}_{11} & 0 \\ {T}_{21} & 0\end{matrix} ] \\ = \frac{1}{det H} \cdot [ \begin{matrix}{T}_{11} \cdot {H}_{22} - {T}_{21} \cdot {H}_{12} & 0 \\ - {T}_{11} \cdot {H}_{21} + {T}_{21} \cdot {H}_{11} & 0\end{matrix} ]\end{matrix}$$

The elements of C are

$${C}_{11} = \frac{{T}_{11} \cdot {H}_{22} - {T}_{21} \cdot {H}_{12}}{det H} {C}_{12} = 0$$

$${C}_{21} = \frac{- {T}_{11} \cdot {H}_{21} + {T}_{21} \cdot {H}_{11}}{det H} {C}_{22} = 0$$

A special case of this operating mode is stopping the motion of the second cone, as described previously. In this case, T₂₁ is also 0. The elements of C are

$${C}_{11} = \frac{{T}_{11} \cdot {H}_{22}}{det H} {C}_{12} = 0$$

$${C}_{21} = \frac{- {T}_{11} \cdot {H}_{21}}{det H} {C}_{22} = 0$$

In this case, the term

$$\frac{{T}_{11}}{det H}$$

is common to both elements and can be moved out in front of the system, leaving only H₂₂ and −H₂₁ as filter terms.

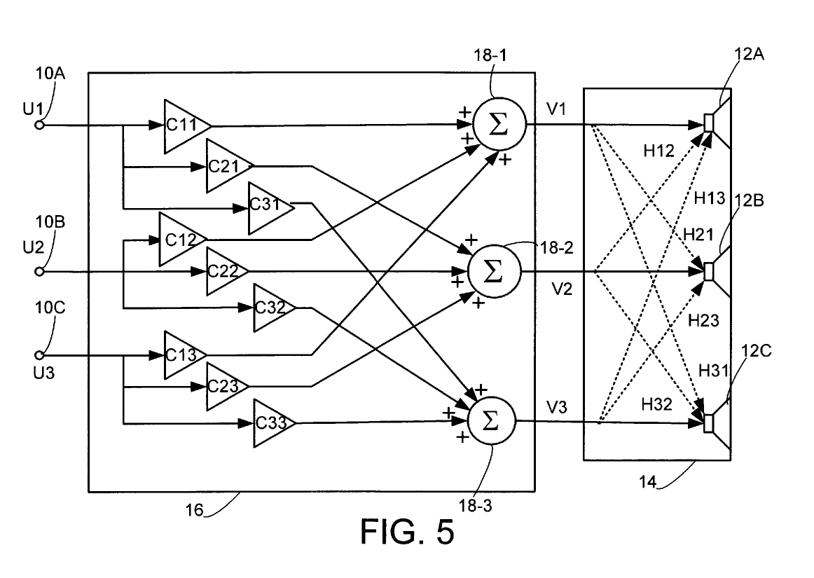

FIG. 5 shows an implementation with three acoustic drivers, 12A, 12B, and 12C, three input signals, 10A, 10B, and 10C, sharing a common enclosure 14. This implementation includes the elements of FIG. 3, and in addition there are canceling transfer functions C₃₁, C₃₂, and C₃₃, coupling input signals U₁, U₂, and U₃, respectively, with a summer 18C, canceling transfer function C₁₃ coupling input signal U₃ with summer 18A, and canceling transfer function C₁₂ coupling input signal U₃ with summer 18B. Summer 18C is coupled to acoustic driver 12C.

Again, the system can be described in matrix notation:

$$[ \begin{matrix}{H}_{11} & {H}_{12} & {H}_{13} \\ {H}_{21} & {H}_{22} & {H}_{23} \\ {H}_{31} & {H}_{32} & {H}_{33}\end{matrix} ] \cdot [ \begin{matrix}{C}_{11} & {C}_{12} & {C}_{13} \\ {C}_{21} & {C}_{22} & {C}_{23} \\ {C}_{31} & {C}_{32} & {C}_{33}\end{matrix} ] = [ \begin{matrix}{T}_{11} & {T}_{12} & {T}_{13} \\ {T}_{21} & {T}_{22} & {T}_{23} \\ {T}_{31} & {T}_{32} & {T}_{33}\end{matrix} ]$$

The solution is

$$[ \begin{matrix}{C}_{11} & {C}_{12} & {C}_{13} \\ {C}_{21} & {C}_{22} & {C}_{23} \\ {C}_{31} & {C}_{32} & {C}_{33}\end{matrix} ] = \frac{1}{det H} \cdot [ \begin{matrix}\begin{matrix}{H}_{22} \cdot {H}_{33} - \\ {H}_{23} \cdot {H}_{32}\end{matrix} & \begin{matrix}- {H}_{12} \cdot {H}_{33} + \\ {H}_{13} \cdot {H}_{32}\end{matrix} & \begin{matrix}{H}_{12} \cdot {H}_{23} - \\ {H}_{13} \cdot {H}_{22}\end{matrix} \\ \begin{matrix}- {H}_{21} \cdot {H}_{33} + \\ {H}_{23} \cdot {H}_{31}\end{matrix} & \begin{matrix}{H}_{11} \cdot {H}_{33} - \\ {H}_{13} \cdot {H}_{31}\end{matrix} & \begin{matrix}- {H}_{11} \cdot {H}_{23} + \\ {H}_{13} \cdot {H}_{21}\end{matrix} \\ \begin{matrix}{H}_{21} \cdot {H}_{32} - \\ {H}_{22} \cdot {H}_{31}\end{matrix} & \begin{matrix}- {H}_{11} \cdot {H}_{32} + \\ {H}_{12} \cdot {H}_{31}\end{matrix} & \begin{matrix}{H}_{11} \cdot {H}_{22} - \\ {H}_{12} \cdot {H}_{21}\end{matrix}\end{matrix} ] \cdot [ \begin{matrix}{T}_{11} & {T}_{12} & {T}_{13} \\ {T}_{21} & {T}_{22} & {T}_{23} \\ {T}_{31} & {T}_{32} & {T}_{33}\end{matrix} ]$$

### With

det H=H₁₁·H₂₂·H₃₃−H₁₁·H₂₃·H₃₂−H₂₁·H₁₂·H₃₃+H₂₁·H₁₃·H₃₂−H₃₁·H₁₂·H₂₃−H₃₁·H₁₃·H₂₂

The final solutions for the elements of C are lengthy terms that are not shown here.

The derivation of cancellation transfer functions for implementations with three acoustic drivers sharing the same enclosure can be applied to implementations with more than three acoustic drivers.

The elements of H are determined using a cone displacement or velocity measurement. Laser vibrometers are particularly useful for this purpose because they require no physical contact with the cone's surface and do not affect its mobility. The laser vibrometer outputs a voltage that is proportional to the measured velocity or displacement.

For an enclosure with two acoustic drivers, transfer function H₁₁ is measured by connecting two power amplifiers (not shown) to the two acoustic drivers and driving acoustic driver 12A with the measurement signal. Acoustic driver 12B is connected to its own amplifier that is powered up but which does not get an input signal. The laser vibrometer measures the cone motion of acoustic driver 12A. Transfer function h₁₂ is measured by using the same setup and directing the laser at Driver 2.

The same technique can be used to measure transfer function H_{xy} in a system with y acoustic drivers by causing acoustic driver y to transduce an audio signal and measuring the effect on acoustic driver x using the laser vibrometer.

Transfer function H₂₂ is measured like transfer function H₁₁, only that now the amplifier of acoustic driver 12A has no input signal and acoustic driver 12B gets the measurement signal. Transfer function H₂₁ is then determined by directing the laser vibrometer at acoustic driver 12A again while exciting acoustic driver 12B.

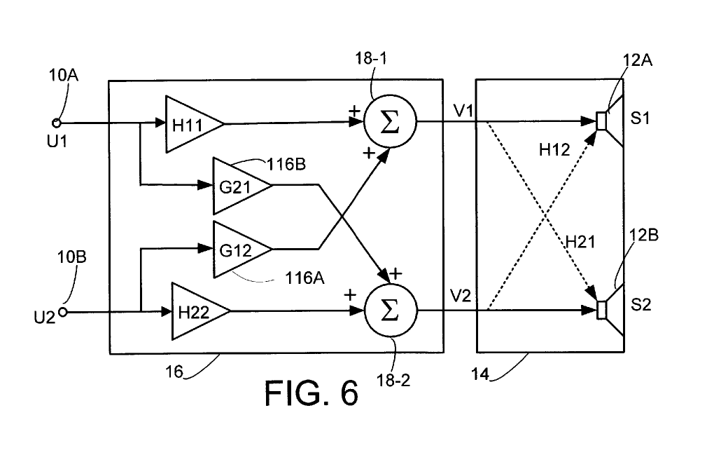

A simpler system for the compensation of cross-talk in an enclosure includes adding a phase inverted transfer function of voltage U₁ to velocity S₂ to the input voltage of Acoustic driver 12B. This solution is shown in FIG. 6. The embodiment of FIG. 5 is similar to the embodiment of FIGS. 2 and 3, but does not have the cancellation adjuster 15. The conventional signal processor 17 of FIG. 2 is not shown in FIG. 5.

In the implementation of FIG. 6, canceller 16 includes a first filter 116A, coupling audio signal source 10A and summer 18-2, and a second filter 116B coupling audio signal source 10B and summer 18-1. In the embodiment of FIG. 2, the movement S₁ and S₂ of acoustic drivers 12A and 12B, respectively, in the absence of filters 116A and 116B can be expressed as

S₁=U₂·H₁₂+U₁·H₁₁ (1)

S₂=U₁·H₂₁+U_{S}·H₂₂ (2)

now we can define functions based on the transfer functions H₁₂ , H₂₁, H₁₁ and H₂₂ as:

$${G}_{12} = \frac{{H}_{12}}{{H}_{11}} and {G}_{21} = \frac{{H}_{21}}{{H}_{22}}$$

and apply G₂₁ at filter 116A and G₁₂ at filter 116B, resulting in modified movements S′₁ and S′₂ as:

S′₁=S₁−U₂·G₁₂·H₁₁

S′₂=S₂−U₁·G₂₁·H₂₂.

Substituting equations (1) and (2) for S₁ and S₂ respectively gives

$${S}_{1}^{′} = {U}_{2} \cdot {H}_{12} + {U}_{1} \cdot {H}_{11} - {U}_{2} \cdot \frac{{H}_{12}}{{H}_{11}} \cdot {H}_{11}$$

$$and$$

$${S}_{2}^{′} = {U}_{1} \cdot {H}_{12} + {U}_{2} \cdot {H}_{22} - {U}_{2} \cdot \frac{{H}_{12}}{{H}_{22}} \cdot {H}_{22} .$$

The first and third terms cancel, resulting in

S′₁=U₁·H₁₁ and

S′₂=U₂·H₂₂,

Which means that the cross-coupling effects have been eliminated.

The system of FIG. 6 provides close results (typically within 1 dB) in the common case in which the cone motion induced by cross-coupling is small relative to the cone motion induced by the direct signal and/or in the case in which the acoustic drivers are nearly identical, which is often the case of the elements of a directional array. In the case of directional arrays, experiments suggest that the cross-talk terms in the matrix Hare in the order of −10 dB. Usually the signal of the canceling transducer is attenuated by 3 to 10 dB. The system of FIG. 6 is substantially equivalent to the system disclosed in U.S. patent application Ser. No. 11/499,014.

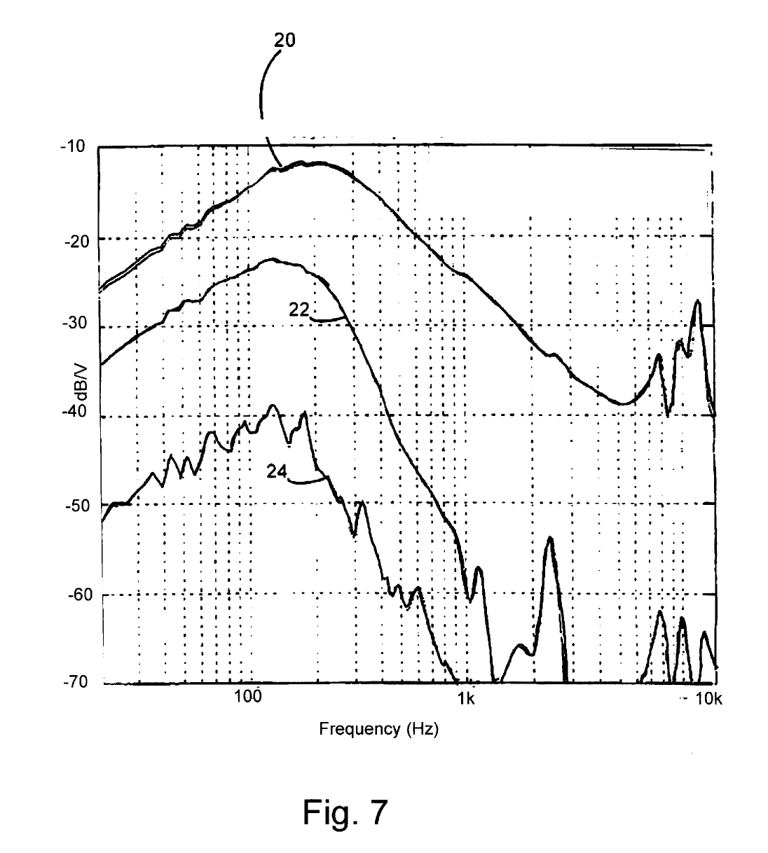

FIG. 7 shows measurements illustrating the effect of the canceller. Curve 20 is the cone velocity of a primary acoustic driver. (Curve 20 is substantially identical with the canceller 16 in operation as it is with the canceller 16 not in operation.) Curve 22 shows the cone velocity of a secondary driver without the canceller 16 in operation, essentially showing the cross-coupling effect. Curve 24 shows the cone velocity of the secondary acoustic driver with the canceller 16 in operation. Curve 24 is approximately 10 to 20 dB less than curve 22, indicating that the canceller reduces the effect of the cross-coupling by 10 to 20 dB.

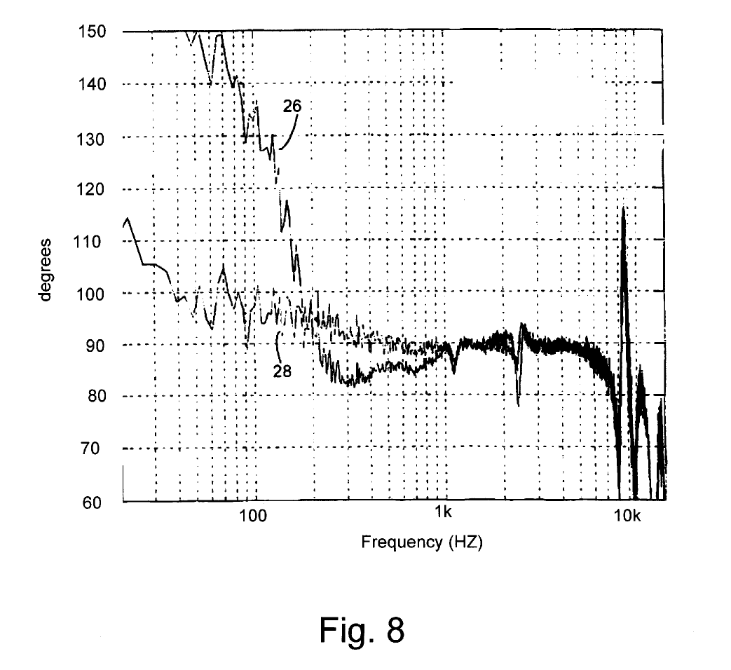

FIG. 8 shows the effect on phase of canceller 16. In the test illustrated in FIG. 7, it is assumed that a constant phase difference of 90 degrees is to be maintained across the entire frequency range. The 90 degree phase shift can be created by filtering the signal with a Hilbert transform. Curve 26 shows the phase difference between the cone velocity of a primary driver and the cone velocity of a secondary driver with the canceller 16 not operating and with a Hilbert transform introduced into the secondary path. Below resonance (for this system approximately 190 Hz), the phase difference varies significantly from 90 degrees. Curve 28 shows the phase difference between the cone velocity of a primary driver and the cone velocity of a secondary driver with the canceller 16 operating and with a Hilbert transform introduced into the secondary path. The phase difference varies from 90 degrees by less than 10 degrees over most of the range of operation of the audio system.

Numerous uses of and departures from the specific apparatus and techniques disclosed herein may be made without departing from the inventive concepts. Consequently, the invention is to be construed as embracing each and every novel feature and novel combination of features disclosed herein and limited only by the spirit and scope of the appended claims.

What is claimed is:

1. Apparatus comprising:
an acoustic enclosure;
a plurality of acoustic drivers mounted in the acoustic enclosure so that motion of each of the acoustic drivers causes motion in each of the other acoustic drivers;
a canceller, to cancel the motion of each of the acoustic drivers caused by motion of each of the other acoustic drivers; and
a cancellation adjuster, to cancel the motion of each of the acoustic drivers that may result from the operation of the canceller.

2. The apparatus of claim 1, wherein the cancellation adjuster adjusts for undesirable phase and frequency response effects that result from the operation of the canceller.

3. The apparatus of claim 1. wherein the cancellation adjuster applies the transfer function matrix
$$[ \begin{matrix}{H}_{11} … {H}_{1 n} \\ ⋮ \\ {H}_{n 1} … {H}_{nn}\end{matrix} ]$$
where each of the matrix elements H_{xy} represents a transfer function from an audio signal Vₓ applied to the input of acoustic driver x to motion represented by velocity S_{y} of acoustic driver y.

4. The apparatus of claim 1, wherein the acoustic drivers are a components of a directional array.

5. The apparatus of claim 1, wherein the acoustic drivers are components of a two-way speaker.

6. A method of operating a loudspeaker having at least two acoustic drivers in a common enclosure, comprising:
determining the effect of the motion of a first acoustic driver on the motion of a second acoustic driver;
developing a first correction audio signal to correct for the effect of the motion of the first acoustic driver on the motion of the second acoustic driver;
determining the effect on the motion of the first acoustic driver of the transducing of the correction audio signal by the second acoustic driver; and
developing a second correction audio signal to correct for the effect on the motion of the first acoustic driver of the transducing of the first correction audio signal by the second acoustic driver.

7. The method of claim 6, wherein the correction audio signal corrects the frequency response and the phase effects on the motion of the first acoustic driver of the transducing of the correction audio signal by the second acoustic driver.

8. The method of claim 6, wherein the second correction audio signal is
$$\frac{1}{det H} ,$$
where H is the transfer function matrix
$$[ \begin{matrix}{H}_{11} … {H}_{1 n} \\ ⋮ \\ {H}_{n 1} … {H}_{nn}\end{matrix} ]$$
where the matrix elements H_{xy} represent the transfer function from an audio signal Vₓ applied to the input of acoustic driver x to motion represented by velocity S_{y} of acoustic driver y.

9. The method of claim 8, further comprising determining matrix elements H_{xy} by causing acoustic driver y to transduce an audio signal, and measuring the effect on acoustic driver x of the transducing by acoustic driver y by a laser vibrometer.

10. The method of claim 8, wherein the motion of acoustic driver is represented by a displacement.

11. The apparatus of claim 1 wherein one of both of the canceller and the cancellation adjuster performs signal processing not related to cross-coupling cancellation.
